(19) United States
(12) Patent Application Publication
(10) Pub. No.: US 2024/0140417 A1
(43) Pub. Date: May 2, 2024

(54) CONTROLLER

(71) Applicant: DENSO CORPORATION, Kariya-city (JP)

(72) Inventors: Takuya KUME, Kariya-city (JP); Kazuki IZUMI, Kariya-city (JP)

(21) Appl. No.: 18/409,064

(22) Filed: Jan. 10, 2024

Related U.S. Application Data
(63) Continuation of application No. PCT/JP22/24937, filed on Jun. 22, 2022.

(30) Foreign Application Priority Data
Jul. 20, 2021 (JP) 2021-119475

(51) Int. Cl. B60W 30/12; B60W 30/18; B60W 60/00

(52) U.S. Cl. CPC B60W 30/12; B60W 30/18163; B60W 60/001

(57) ABSTRACT

A controller executes lane change control or passing control of a vehicle capable of automated driving. The controller includes at least one processor, and at least one memory which is a non-transitory tangible storage medium configured to store data and program instructions to be used by the processor. The at least one processor is, when the program instructions stored in the at least one memory is executed by the at least one processor, configured to carry out restricting the lane change control or the passing control in a case where continuation of the automated driving or smooth behavior control of the vehicle is estimated to be difficult.

### CROSS REFERENCE TO RELATED APPLICATIONS

The present application is a continuation application of International Patent Application No. PCT/JP2022/024937 filed on Jun. 22, 2022, which designated the U.S. and claims the benefit of priority from Japanese Patent Application No. 2021-119475 filed on Jul. 20, 2021. The entire disclosures of all of the above applications are incorporated herein by reference.

### TECHNICAL FIELD

The present disclosure relates to a controller for a vehicle.

### BACKGROUND

Various techniques for automatically executing lane change control by an in-vehicle system have been proposed.

### SUMMARY

According to an aspect of the present disclosure, a controller is configured to execute lane change control or passing control of a vehicle capable of automated driving. The controller includes at least one processor, and at least one memory which is a non-transitory tangible storage medium configured to store data and program instructions to be used by the processor. The at least one processor is, when the program instructions stored in the at least one memory is executed by the at least one processor, configured to carry out restricting the lane change control or the passing control in a case where continuation of the automated driving or smooth behavior control of the vehicle is estimated to be difficult.

### BRIEF DESCRIPTION OF DRAWINGS

The details of one or more embodiments are set forth in the accompanying drawings and the description below. Other features and advantages will be apparent from the description and drawings, and from the claims.

FIG. 1 is a block diagram illustrating a schematic configuration of an in-vehicle system including a controller according to an embodiment.

FIG. 2 is a block diagram illustrating a schematic functional configuration of a driving controller shown in FIG. 1.

FIG. 3 is a block diagram illustrating a schematic functional configuration of an HMI controller illustrated in FIG. 1.

FIG. 4 is a flowchart illustrating an operation example in the in-vehicle system shown in FIG. 1.

FIG. 5 is a flowchart illustrating an operation example in the in-vehicle system shown in FIG. 1.

FIG. 6 is a flowchart illustrating an operation example in the in-vehicle system shown in FIG. 1.

FIG. 7 is a flowchart illustrating an operation example in the in-vehicle system shown in FIG. 1.

FIG. 8 is a flowchart illustrating an operation example in the in-vehicle system shown in FIG. 1.

FIG. 9 is a flowchart illustrating an operation example in the in-vehicle system shown in FIG. 1.

FIG. 10 is a flowchart illustrating an operation example in the in-vehicle system shown in FIG. 1.

### DETAILED DESCRIPTION

Examples of relevant techniques will be described. Various techniques for automatically executing lane change control by an in-vehicle system have been proposed. For example, an automated-driving device according to a comparative example executes control to change a lane of a subject vehicle to another lane when it is sensed that the lane in which the subject vehicle is traveling is congested.

For example, the subject vehicle controlled in automated driving in which a driver is obligated to monitor the surroundings may encounter a scene where a lane change is necessary or recommended, or a scene where the driver wants to change lanes. Here, there are various traffic environments when the lane change control is automatically executed by the in-vehicle system. For example, a behavior of the subject vehicle at the time of lane change and a time actually required for lane change may change according to a vehicle speed of the subject vehicle, a traffic condition on the road on which the subject vehicle is currently traveling.

According to the present disclosure, a technique for improving convenience of a vehicle capable of automatic lane change control executed by an in-vehicle system can be provided.

According to an aspect of the present disclosure, a controller is configured to execute lane change control causing a vehicle capable of automated driving to make a lane change. The lane change control includes at least automated steering control. The controller includes at least one processor, and at least one memory which is a non-transitory tangible storage medium configured to store data and program instructions to be used by the processor. The at least one processor is, when the program instructions stored in the at least one memory is executed by the at least one processor, configured to carry out restricting the lane change control regardless of an instruction of a driver to start a lane change during automated driving without an obligation of surrounding monitoring in a first case where a transition region where a driving automation level changes is located within a predetermined distance or within a predetermined time from the vehicle, or in a second case where a merging point or a curve point is present in a lane change destination region.

According to another aspect of the present disclosure, a controller is configured to execute passing control causing a vehicle capable of automated driving to pass another vehicle. The passing control includes at least automated steering control. The controller includes at least one processor, and at least one memory which is a non-transitory tangible storage medium configured to store data and program instructions to be used by the processor. The at least one processor is, when the program instructions stored in the at least one memory is executed by the at least one processor, configured to carry out restricting the passing control in a first case or a second case. The first case is where a transition region where a driving automation level changes is located within a predetermined distance or within a predetermined time from a lane re-change point at which a lane re-change is scheduled to be executed for the vehicle returning from an adjacent lane to an originally traveling lane after a lane change from the originally traveling lane to the adjacent lane for passing the other vehicle. The originally traveling lane is a lane in which the vehicle is traveling before a start of the passing control. The second case is where a merging point or a curve point is present in a lane change destination region at the lane re-change point.

According to another aspect of the present disclosure, a controller is for a vehicle capable of automated driving. The vehicle is configured to execute passing control causing the vehicle to pass another vehicle, and the passing control includes at least automated steering control. The controller includes at least one processor, and at least one memory which is a non-transitory tangible storage medium configured to store data and program instructions to be used in the processor. The at least one processor is, when the program instructions stored in the at least one memory is executed by the at least one processor, configured to carry out executing a notification prompting a driver to perform surrounding monitoring at a time of a lane change during the passing control when having received a driver's instruction to start execution of the passing control during automated driving without an obligation of surrounding monitoring.

Hereinafter, an embodiment of the present disclosure will be described with reference to the drawings. If descriptions of various modifications applicable to one embodiment are sequentially inserted in the middle of a series of descriptions regarding the embodiment, understanding of the embodiment may be hindered. Therefore, the modifications will be described not in the middle of the series of descriptions regarding the embodiment, but collectively described after the series of descriptions.

### (In-Vehicle System Configuration)

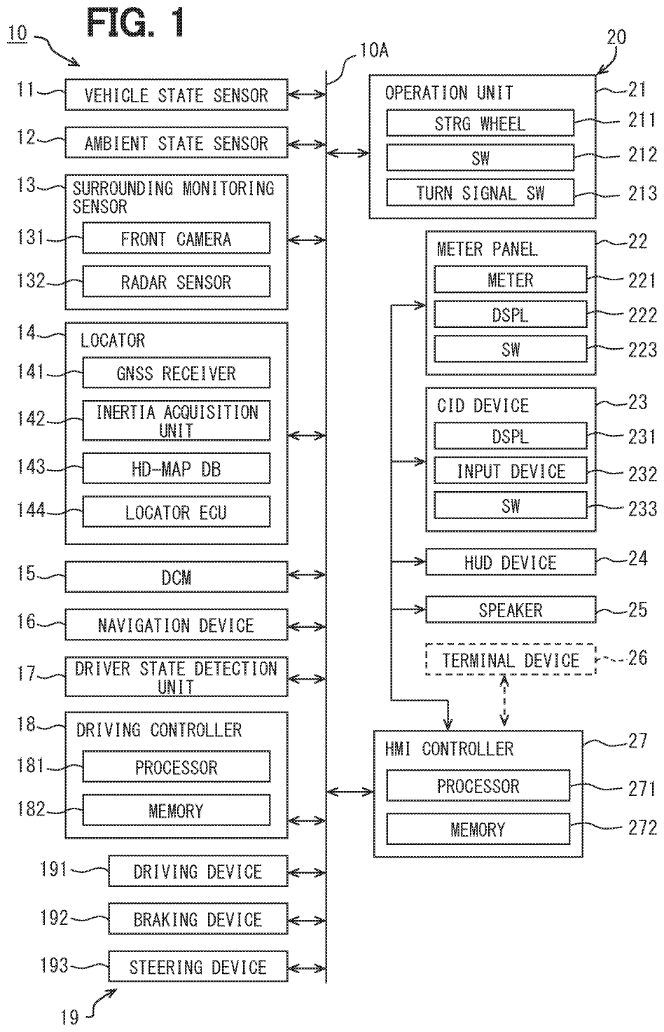

Referring to FIG. 1, an in-vehicle system 10 is configured to be mounted on an automobile as a vehicle so that the in-vehicle system 10 executes a function as a driving automation system in the vehicle. Hereinafter, the vehicle on which the in-vehicle system 10 is mounted may be referred to as a “subject vehicle”. More specifically, in the present embodiment, the in-vehicle system 10 is configured to execute at least automated steering driving.

The term “automated steering driving” means a mode in which the driving automation system is in charge of or executes at least steering, that is, a control subtask related to a lateral vehicle motion, among the dynamic driving tasks defined in the standard “SAE J3016” published by SAE International. SAE is an abbreviation for Society of Automotive Engineers. The “dynamic driving tasks” are all operational and tactical functions that need to be executed in real time when a vehicle is operated in road traffic, excluding strategic functions. The “strategic functions” are trip scheduling, waypoint selection, and the like, or more specifically, include determining or selecting “whether to go, and when, where, and how to go”.

That is, the “automated steering driving” is typically a driving automation level corresponding to level 1 or level 2 in “SAE J3016”. However, the “automated steering driving” is a concept including so called “automated driving”. The “automated driving” means a driving automation level that corresponds to levels 3 to 5 in “SAE J3016” and at which the driving automation system is in charge of, that is, executes all the dynamic driving tasks. The level X in “SAE J3016” is hereinafter simply referred to as “SAE level X”. X is any of 0 to 5.

Hereinafter, the driving automation level becomes “higher” as the numerical value of X of the SAE level X is larger, or as the number of the dynamic driving tasks that the driving automation system is in charge of, that is, executes increases. The change of the driving automation level to a higher level is referred to as a “rise” in the driving automation level. On the other hand, the driving automation level becomes “lower” as the numerical value of X described above is smaller, or as the number of the dynamic driving tasks that the driving automation system is in charge of, that is, executes decreases. The change of the driving automation level to a lower level is referred to as a “drop” in the driving automation level.

The contents of SAE levels 0 to 5 are specifically as follows. In the following description of the contents of each level, a “driver” is an occupant in charge of or executing the dynamic driving tasks, typically, an occupant seated in a driver's seat of the subject vehicle, and may also be referred to as a “driver's seat occupant”. “OEDR” is an abbreviation for Object and Event Detection and Response, and is also referred to as “detection and response of an object and an event”. OEDR includes monitoring the driving environment. The monitoring of the driving environment includes detection, recognition, and classification of objects and events. The monitoring of the driving environment also includes preparation to respond to the objects and the events as needed. A “limited region” is a specific condition under which a certain driving automation system or its function operates, and is also referred to as an operation design region or ODD. ODD is an abbreviation for Operational Design Domain. The limited region includes at least one of constraints, such as geographical constraint, environmental constraint, speed constraint, and temporal constraint.

SAE Level 0 indicates a manual operation in which the driver performs all of the dynamic operation tasks.

SAE Level 1 indicates a driving assistance in which the driving automation system continuously executes one of control subtasks related to a longitudinal vehicle motion and a lateral vehicle motion among the dynamic driving tasks in the specific limited region. The control subtask related to the longitudinal vehicle motion includes starting, acceleration/deceleration, and stopping. The control subtask related to the lateral vehicle motion includes steering. However, the driving automation system does not simultaneously execute both of the control subtasks related to the longitudinal vehicle motion and the lateral vehicle motion.

SAE Level 2 indicates an advanced driving assistance in which the driving automation system continuously executes both of the control subtasks related to the longitudinal vehicle motion and the lateral vehicle motion among the dynamic driving tasks in the specific limited region. The driver is expected to supervise the driving automation system by performing the OEDR, which is a subtask of the dynamic driving task.

SAE Level 3 indicates a conditional automated driving in which the driving automation system continuously executes all the dynamic driving tasks in the specific limited region. In principle, the driver is not obliged to perform the OEDR such as surrounding monitoring (i.e., monitoring of a traffic environment around the subject vehicle). However, in a case where this driving automation level has difficulty continuing, the driving automation system requests the driver to take over the driving tasks with sufficient time. The driver is required to appropriately respond to the request.

SAE Level 4 indicates a highly automated driving, and the driving automation system continuously executes all the dynamic driving tasks in a specific limited region. In the limited region, when the driving automation level has difficulty continuing, the driving automation system handles the difficulty.

SAE Level 5 indicates a fully automated driving in which the driving automation system continuously executes all the dynamic driving tasks without any limitation regardless of the specific limited region. In a case where the driving automation level has difficulty continuing, the driving automation system handles the difficulty without any limitation regardless of the specific limited region.

In the present embodiment, the in-vehicle system 10 is configured to implement the driving automation levels of SAE levels 0 to 3 in the subject vehicle. More specifically, the in-vehicle system 10 is configured to execute ACC and LKA corresponding to SAE level 1. ACC is an abbreviation for Adaptive Cruise Control, and is inter-vehicle distance control. LKA is an abbreviation for Lane Keeping Assistance and is lane keeping assist control.

The in-vehicle system 10 is also configured to execute hands-on driving and hands-off driving corresponding to SAE level 2. The “hands-on driving” is a driving automation level at which the driving automation system operating in parallel with the driver's driving timely executes driving control or driving assistance control on the assumption that the driver drives the subject vehicle. That is, the “hands-on driving” is advanced driving assistance that requests the driver to be in a hands-on state and perform the surrounding monitoring as one of the dynamic driving tasks. The “surrounding monitoring” means monitoring the traffic environment around the subject vehicle, and more specifically, includes monitoring a road situation, monitoring a traffic situation, and monitoring a presence state of an obstacle. The “road situation” means a topographical situation of a road, such as presence or absence of a curve, or a curve curvature. The “traffic situation” means a traffic volume, that is, a presence situation of other vehicles. The “presence state of an obstacle” includes presence or absence, a type, a relative position, a relative speed, and the like of the obstacle. The “obstacle” includes a person, an animal, parked and stopped vehicles, an object dropped on the road, and the like. The “hands-on state” is a state in which the driver can interfere with the steering of the subject vehicle, that is, the control task related to the lateral vehicle motion. The “hands-on state” is typically a state in which the driver grips a steering wheel 211 described later. The “hands-off driving” is a driving automation level at which the driving automation system automatically executes controls for starting, steering, acceleration/deceleration and stopping on condition that the driver appropriately responds to an intervention request or the like from the driving automation system. That is, the “hands-off driving” is advanced driving assistance that does not request the driver to be in the hands-on state but requests the driver to perform the surrounding monitoring as one of the dynamic driving tasks. The in-vehicle system 10 is configured to execute LCA during the hands-on driving and the hands-off driving. The LCA is an abbreviation for Lane Change Assist, and is automatic lane change assistance in which lane change is automatically performed and triggered by a turn-signal operation as an operation for execution start instruction.

In addition, the in-vehicle system 10 is configured to be capable of executing automated driving corresponding to SAE level 3 on condition that the vehicle travels on a predetermined automated drivable road in a legal speed range. Hereinafter, in the present specification, unless otherwise specified, such automated driving is simply referred to as “automated driving”. The “automated drivable road” is a road only for automobiles preliminarily set as a road on which the automated driving is possible. The automated drivable road is typically a road that is only for automobiles and has a legal maximum speed exceeding 60 km/h. For example, the automated drivable road is an expressway. Here, in the present embodiment, conditions for executing the automated driving includes a condition that the subject vehicle is not traveling in a passing lane and a condition that the subject vehicle is not traveling in an impediment section. The “impediment section” is a point or a section on a road where an impediment such as a traffic accident, road construction, or road maintenance work occurs. Further, the in-vehicle system 10 is configured to execute a lane change control and a passing control during the automated driving under a condition that the vehicle does not enter a passing lane. The “lane change control” is vehicle driving control necessary for lane change and includes at least automated steering control. The “passing control” is vehicle driving control necessary for passing another vehicle traveling ahead of the subject vehicle in a subject lane which is a traveling lane of the subject vehicle and returning to the subject lane. The passing control includes the lane change control and acceleration/deceleration control.

As described above, the in-vehicle system 10 is configured to execute the hands-on driving and the hands-off driving in which the obligation of the surrounding monitoring is imposed on the driver, and the automated driving in which the obligation of the surrounding monitoring is not imposed on the driver, as the automated steering control. In the present embodiment, it is assumed that the hands-off driving is executed under a condition that the subject vehicle is traveling on the automated drivable road. That is, it is assumed that the in-vehicle system 10 is configured not to execute either the hands-off driving or the automated driving on the general road.

The in-vehicle system 10 is an in-vehicle network including an in-vehicle communication line 10A, and multiple nodes and the like connected to each other via the in-vehicle communication line 10A. The in-vehicle system 10 is configured to execute various types of vehicle controls during driving of the subject vehicle, and various notification operations accompanying the various vehicle controls. The in-vehicle system 10 is configured to conform to a predetermined communication standard such as CAN (international registered trademark: international registered number 1048262A). CAN (international registered trademark) is an abbreviation for Controller Area Network.

The in-vehicle system 10 includes a vehicle state sensor 11, an ambient state sensor 12, a surrounding monitoring sensor 13, a locator 14, a communication module 15, and a navigation device 16. The in-vehicle system 10 includes a driver state detection unit 17, a driving controller 18, a traveling device 19, and an HMI device 20. HMI is an abbreviation for Human-Machine Interface.

The HMI device 20 includes an operation unit 21, a meter panel 22, a CID device 23, a HUD device 24, a speaker 25, and a terminal device 26, as input/output devices. CID is an abbreviation for Center Information Display. HUD is an abbreviation for Head-Up Display. The HMI device 20 includes an HMI controller 27 that controls display and/or sound output operations in these input/output devices.

The operation unit 21 is connected to the HMI controller 27 via the in-vehicle communication line 10A for information communication with the HMI controller 27. The meter panel 22, the CID device 23, the HUD device 24, and the speaker 25 are connected to the HMI controller 27 via a sub communication line different from the in-vehicle communication line 10A, for information communication with the HMI controller 27. The terminal device 26 is a portable or wearable electronic device brought into the subject vehicle by an occupant of the subject vehicle including the driver. For example, the terminal device 26 is a mobile phone, a tablet terminal, a notebook computer, a portable game machine, a smart watch, or the like. When the terminal device 26 is brought into the subject vehicle, the terminal device 26 is configured to be connected to the HMI controller 27 for information communication by short-range wireless communications such as Bluetooth (registered trademark) and TransferJet (registered trademark). The HMI controller 27 is provided as a node connected to the in-vehicle communication line 10A.

### (Various Sensors)

The vehicle state sensor 11 is configured to generate outputs corresponding to various parameters related to a driving state of the subject vehicle. The “various parameters related to the driving state” include various parameters related to a state of driving operation by the driver or by the driving automation system, such as an accelerator operation amount, a brake operation amount, a gear position, and a steering angle. The “various parameters related to the driving state” also include physical quantities related to a behavior of the subject vehicle, such as a vehicle speed, an angular velocity, longitudinal acceleration, and lateral acceleration. Therefore, the vehicle state sensor 11 is a generic term for well-known sensors necessary for vehicle driving control, such as an accelerator sensor, a steering angle sensor, a wheel speed sensor, an angular velocity sensor, and an acceleration sensor, for simplification of illustration and description. The vehicle state sensor 11 is configured to transmit detection outputs to respective units such as the driving controller 18 via the in-vehicle communication line 10A.

The ambient state sensor 12 is configured to generate outputs corresponding to various parameters mainly related to a natural environment among the traffic environment around the subject vehicle. The “various parameters related to the natural environment” include physical quantities, such as an outside air temperature, rainfall, and illuminance. That is, the ambient state sensor 12 is a generic term for well-known sensors, such as an outside air temperature sensor, a raindrop sensor, and an illuminance sensor, for simplification of illustration and description. The ambient state sensor 12 is configured to transmit detection outputs to respective units such as the driving controller 18 via the in-vehicle communication line 10A.

The surrounding monitoring sensor 13 is configured to mainly detect a traffic environment around the subject vehicle except for the traffic environment detected by the ambient state sensor 12. More specifically, the surrounding monitoring sensor 13 is configured to detect a moving object and a stationary object in a predetermined detection range around the subject vehicle. The “moving object” includes a pedestrian, a cyclist, an animal, and another vehicle that is driving. The “stationary object” includes a fallen object on the road, a guardrail, a curb, a parked and stopped vehicle, a road sign, a road surface marking, and roadside structures (e.g., a wall and a building). The surrounding monitoring sensor 13 may also be referred to as an “ADAS sensor”. ADAS is an abbreviation for Advanced Driver-Assistance Systems.

In the present embodiment, the surrounding monitoring sensor 13 includes a front camera 131 and a radar sensor 132 as a configuration for detecting the moving object and the stationary object. The front camera 131 is configured to capture images on the front side and the front lateral side of the subject vehicle. The front camera 131 is a digital camera device and includes an image sensor such as a CCD or CMOS. CCD is an abbreviation for Charge Coupled Device. CMOS is an abbreviation for Complementary Metal Oxide Semiconductor.

The radar sensor 132 is a millimeter-wave radar sensor, a sub-millimeter-wave radar sensor, or a laser radar sensor configured to transmit and receive radar waves. The radar sensor 132 is mounted on a front surface portion of a vehicle body of the subject vehicle. The radar sensor 132 is configured to output a signal corresponding to a position and a relative speed of a reflection point. The “reflection point” is a point that is on a surface of an object existing around the subject vehicle and is assumed to have reflected the radar wave. The “relative speed” is a relative speed of the reflection point, that is, an object that has reflected the radar wave, relative to the subject vehicle.

### (Locator)

The locator 14 is configured to determine, for example, highly accurate position information of the subject vehicle by so-called combined positioning. More specifically, the locator 14 has a GNSS receiver 141, an inertia acquisition unit 142, a high-definition map DB 143, and a locator ECU 144. GNSS is an abbreviation for Global Navigation Satellite System. DB is an abbreviation for database. ECU is an abbreviation for Electronic Control Unit. The “highly accurate position information” is, for example, position information having a position accuracy that can be used for the advanced driving assistance or the automated driving of SAE level 2 or higher. More specifically, the position information may have an error less than 10 cm.

The GNSS receiver 141 is configured to receive positioning signals transmitted from multiple positioning satellites, that is, artificial satellites. In the present embodiment, the GNSS receiver 141 is configured to receive positioning signals from positioning satellites in at least one of satellite positioning systems such as GPS, QZSS, GLONASS, Galileo, IRNSS, and Hokuto satellite navigation system. GPS is an abbreviation for Global Positioning System. QZSS is an abbreviation for Quasi-Zenith Satellite System. GNSS is an abbreviation for Global Navigation Satellite System. IRNSS is an abbreviation for Indian Regional Navigation Satellite System.

The inertia acquisition unit 142 is configured to acquire acceleration and angular velocity of the subject vehicle. In the present embodiment, the inertia acquisition unit 142 is provided as a three-axis gyro sensor and a three-axis acceleration sensor built in a box-shaped housing of the locator 14.

The high-definition map DB 143 is mainly formed by a nonvolatile rewritable memory so as to store high-definition map information in a rewritable manner and to hold the stored contents even during power interruption. The nonvolatile rewritable memory is, for example, a hard disk, an EEPROM, or a flash ROM. EEPROM is an abbreviation for Electronically Erasable and Programmable ROM. ROM is an abbreviation for Read Only Memory. The high-definition map information may also be referred to as high-definition map data. The high-definition map information includes map information more accurate than map information used in a conventional car navigation system corresponding to a position error of about several meters. More specifically, the high-definition map DB 143 stores information that can be used for the advanced driving assistance or the automated driving, such as three-dimensional road shape information, lane number information, and regulation information, in accordance with a predetermined standard, such as the ADASIS standard. ADASIS is an abbreviation for Advanced Driver Assistance Systems Interface Specification.

The locator ECU 144 is configured as a so-called in-vehicle microcontroller provided with a CPU, a ROM, a RAM, and an input/output interface, for example. CPU is an abbreviation for Central Processing Unit. RAM is an abbreviation for Random Access Memory. The locator ECU 144 is configured to sequentially determine the position, the direction, and the like of the subject vehicle based on, for example, the positioning signals received by the GNSS receiver 141, the acceleration and the angular velocity acquired by the inertia acquisition unit 142, and the vehicle speed acquired from the vehicle state sensor 11. Then, the locator 14 is configured to transmit the determination result of by the locator ECU 144, such as the position and the direction, to components such as the navigation device 16, the driving controller 18, and the HMI controller 27 via the in-vehicle communication line 10A.

### (Communication Module)

The communication module 15 is an in-vehicle communication module also referred to as a DCM, and is configured to execute information communication with a base station around the subject vehicle via wireless communications conforming to a communication standard such as LTE or 5G. DCM is an abbreviation for Data Communication Module. LTE is an abbreviation for Long Term Evolution. 5G is an abbreviation for 5th Generation.

For example, the communication module 15 is configured to acquire latest high-definition map information from a probe server on a cloud. Further, the communication module 15 stores the acquired latest high-definition map information in the high-definition map DB 143 in cooperation with the locator ECU 144. The communication module 15 is configured to acquire traffic information such as congestion information from the above-described probe server and/or a predetermined database. The “congestion information” includes a position and a length of a congestion section. More specifically, the congestion information includes a congestion head position, a congestion tail position, an estimated congestion distance, and an estimated congestion time. The traffic information is also referred to as “road traffic information”.

### (Navigation Device)

The navigation device 16 is configured to calculate a planned travel route from the current position of the subject vehicle to a predetermined destination. In the present embodiment, the navigation device 16 is configured to calculate a planned travel route based on a destination set by a driver or the like of the subject vehicle, the high-definition map information acquired from the locator 14, and position information and direction information of the subject vehicle acquired from the locator 14, for example. The navigation device 16 is configured to transmit calculation results as various types of information including route information to components such as the driving controller 18 and the HMI controller 27 via the in-vehicle communication line 10A. That is, the navigation device 16 causes the HMI device 20 to display a navigation screen for map display, route display, and the like.

### (Driver State Detection Unit)

The driver state detection unit 17 is configured to detect a driver state. The “driver state” is a state of the driver in the subject vehicle. The “driver state” includes a behavior of the deriver and an awakening state of the driver. The “behavior of the driver” includes a face direction, line-of-sight direction, posture, and the like of the driver. Further, the driver state detection unit 17 is configured to transmit a driver state detection result to components such as the driving controller 18 and the HMI controller 27 via the in-vehicle communication line 10A.

More specifically, the driver state detection unit 17 is configured to detect the driver state by image recognition based on an image captured by an in-vehicle camera including an image sensor, such as a CCD or a CMOS. That is, the driver state detection unit 17 is configured to constitute a so-called driver status monitor that warns of a decrease in the awakening state of the driver or the like. The driver state detection unit 17 is also configured to detect an operation state of an accelerator and a brake operated by the driver, a gripping state and an operation state of the steering wheel 211 held and operated by the driver, and the like.

### (Driving Controller)

The driving controller 18 is configured to control driving of the subject vehicle based on signals and information acquired from the vehicle state sensor 11, the ambient state sensor 12, the surrounding monitoring sensor 13, the locator 14, and the like. The driving controller 18 has a configuration as a control unit, that is, an automated driving ECU that controls the operation of the driving automation system (i.e., an automated driving system) that implements driving automation levels corresponding to SAE levels 1 to 3. More specifically, the driving controller 18 is configured to execute the lane change control and the passing control in the subject vehicle capable of automated driving. The lane change control is driving control for lane change and includes at least the automated steering control. The passing control is driving control for passing and includes at least the automated steering control. The driving controller 18 has a configuration as a so-called in-vehicle microcontroller including a processor and a memory. That is, the driving controller 18 includes a driving control processor 181 and a driving control memory 182. The driving control processor 181 includes a CPU, a RAM, and an input/output interface. The driving control processor 181 is configured to execute program instructions stored in the driving control memory 182 to cause the in-vehicle system 10 to execute the longitudinal and/or lateral vehicle motion control subtasks. The driving control memory 182 is a non-transitory tangible storage medium that stores data and program instructions used by the driving control processor 181 and includes a ROM and/or a non-volatile rewritable memory. Details of various functions executed by the driving controller 18 in the present embodiment will be described later.

### (Traveling Device)

The traveling device 19 includes a driving device 191, a braking device 192, and a steering device 193. The driving device 191 generates a driving force of the vehicle, and includes a power source device that is an electric motor and/or an engine, and a power transmission mechanism that transmits the driving force from the power source device to an axle. The braking device 192 is configured to generate a braking force by a friction brake and/or a regenerative brake. The steering device 193 is a power steering device and is configured to control the direction of steered wheels.

### (HMI Device)

The HMI device 20 is a so-called vehicle HMI and has a configuration for executing information transmission between the subject vehicle and an occupant including the driver. More specifically, the HMI device 20 is configured to present various types of information relating to the subject vehicle to the driver at least visually, and receive input operation of the driver corresponding to the presented contents. The various types of information to be presented are, for example, various types of guidance, an input-operation instruction, an input-operation content notification, and a warning.

The operation unit 21 is configured to receive various operations including a driving operation of the driver and transmit a reception result of the operations to components such as the driving controller 18 and the HMI controller 27 via the in-vehicle communication line 10A. Specifically, the operation unit 21 includes the steering wheel 211, a steering switch 212 and a turn signal switch 213.

The steering wheel 211 is fixed to a steering shaft rotatably supported by a steering column. The steering switch 212 is provided on a spoke portion or the like of the steering wheel 211. The turn signal switch 213 is configured to output a signal corresponding to an operation state of a turn signal lever which is an operation lever provided in the steering column.

The HMI device 20 includes the meter panel 22, the CID device 23, and the HUD device 24 which are provided on a dashboard. That is, in the present embodiment, the HMI device 20 has a configuration as a so-called “dashboard HMI” mainly including devices attached to the dashboard.

The meter panel 22 includes a meter 221, a meter display 222, and a meter switch 223. The meter 221 is configured to execute meter display, such as a vehicle speed, a cooling water temperature, and a remaining amount of fuel, and the like of the subject vehicle. The meter display 222 is an information display portion or an information display region provided in a central portion of the meter panel 22 in a vehicle width direction, and is configured to display various types of information such as date and time, an outside air temperature, a travel distance, and a radio reception station. In the present embodiment, the meter display 222 has a configuration as a display device that is a liquid crystal display or an organic EL display having a substantially rectangular displayable region. EL is an abbreviation for electroluminescence. The meter switch 223 is configured to receive various operations related to a display state or display content on the meter 221 and/or the meter display 222.

The CID device 23 is configured to display a navigation window for map display, route display, and the like by the navigation device 16. Further, the CID device 23 is configured to display information and content different from those on the navigation window.

Specifically, the CID device 23 is configured to display information and execute a setting operation related to traveling modes, such as “comfort”, “normal”, “sports”, and “circuit”. The CID device 23 is configured to also display information related to second tasks available to the driver during the automated driving of SAE level 3. The second tasks are tasks executed by the driver except for driving operation. More specifically, the second tasks include book reading, portable communication terminal operation, and video content viewing. The second tasks are also referred to as “non-driving tasks” or “secondary activities”.

The CID device 23 has a CID display 231, an input device 232, and a CID switch 233. The CID display 231 is provided at a substantially central position of the dashboard in the vehicle width direction, more specifically, at a position between the driver's seat and the front passenger's seat so as to be visible at least from the driver. The CID display 231 has a configuration as a display device which is a liquid crystal display or an organic EL display. The CID display 231 is configured to display video in a video content when the second task is viewing the video content. The “video content” is, for example, a movie, a concert video, a music video, or a television broadcast.

The input device 232 is a transparent touch panel and is provided to cover the CID display 231 by being stacked over the CID display 231. That is, the input device 232 is configured to allow the driver or the like to visually recognize a display on the CID display 231 and to receive an input operation by the driver or the like corresponding to the display. The CID switch 233 includes manually operation switches arranged around the CID display 231 and the input device 232.

The HUD device 24 is provided to display a display image including a character and/or a symbol in a front view of the driver. In the present embodiment, the HUD device 24 is configured to superimpose and display a display image on a front landscape including a road surface of a traveling destination of the subject vehicle by generating a virtual display image in front of the driver using an AR technology. AR is an abbreviation for Augmented Reality. More specifically, the HUD device 24 has a configuration in which display image light is projected onto a predetermined projection range of a front windshield, and the driver visually recognizes reflected light of the display image light by the front windshield, thereby executing AR display of the display image. The “superimposition display” by the HUD device 24 is to display information (e.g., a building name) related to a superimposition target (e.g., a building) included in the front landscape. For example, the related information is displayed so as to overlap the superimposition target or in the vicinity of the superimposition target. Various displays such as a route display, a traveling direction display, and a traffic information display on the road surface ahead also correspond to the “superimposed display”.

The HMI device 20 includes a speaker 25 for executing voice output including information presentation by voice. That is, the speaker 25 is provided so as to output a sound corresponding to a display content on the meter panel 22, the CID device 23, and the HUD device 24. In addition, the speaker 25 is configured to output a sound (e.g., music, radio sound, etc.) that does not correspond to the display content on the meter panel 22, the CID device 23, and the HUD device 24. The speaker 25 is configured to function as a sound output device for the terminal device 26 when the terminal device 26 brought into the subject vehicle is connected to the HMI controller 27 by short-range wireless communication. Furthermore, the HMI device 20 is configured to cause the terminal device 26 to output a display content and sound corresponding to the display content on the meter panel 22 when the terminal device 26 brought into the subject vehicle is connected to the HMI controller 27 by short-range wireless communications.

### (HMI Controller)

The HMI controller 27 is configured to control the operation of the HMI device 20. That is, the HMI controller 27 has a configuration as an HCU that controls operations of the meter panel 22, the CID device 23, the HUD device 24, and the like included in the HMI device 20. HCU is an abbreviation for HMI Control Unit.

The HMI controller 27 has a configuration as a so-called in-vehicle microcontroller including a processor and a memory. That is, the HMI controller 27 includes an HCU processor 271 and an HCU memory 272. The HCU processor 271 includes a CPU, a RAM, and an input/output interface. The HCU processor 271 is configured to control display output and audio output in the HMI device 20 by executing program instructions stored in the HCU memory 272. The HCU memory 272 is a non-transitory tangible storage medium that stores data and program instructions used by the HCU processor 271 and includes ROM and/or non-volatile rewritable memory. Details of various functions executed by the HMI controller 27 in the present embodiment will be described later.

### First Embodiment

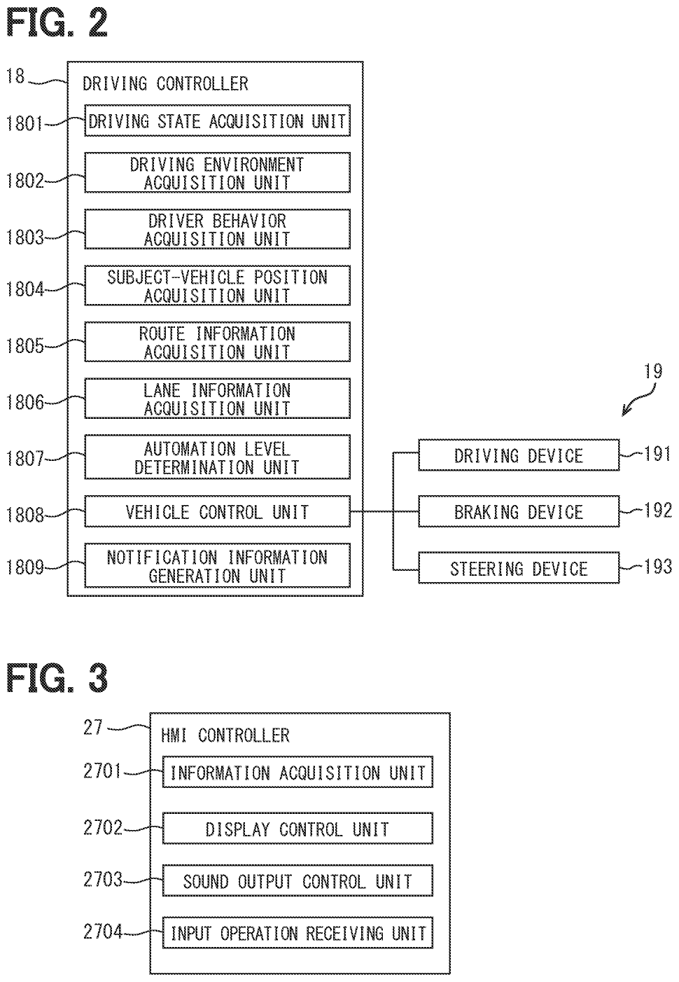

FIG. 2 illustrates functional configuration units or functional configuration blocks implemented in the driving controller 18 via execution of program instructions. As illustrated in FIG. 2, the driving controller 18 includes a driving state acquisition unit 1801, a driving environment acquisition unit 1802, a driver behavior acquisition unit 1803, and a subject-vehicle position acquisition unit 1804 as functional components or functional units realized on the in-vehicle microcontroller. The driving controller 18 includes a route information acquisition unit 1805, a lane information acquisition unit 1806, an automation level determination unit 1807, a vehicle control unit 1808, and a notification information generation unit 1809 as functional configurations or a functional units realized on the in-vehicle microcontroller.

The driving state acquisition unit 1801 acquires information corresponding to the various parameters related to the driving state of the subject vehicle detected by the vehicle state sensor 11. The driving environment acquisition unit 1802 acquires information corresponding to the traffic environment around the subject vehicle detected by the ambient state sensor 12 and the surrounding monitoring sensor 13. The driver behavior acquisition unit 1803 is configured to acquire the behavior of the driver in the subject vehicle. More specifically, the driver behavior acquisition unit 1803 acquires (i.e., receives) the behavior of the driver detected by the driver state detection unit 17 from the driver state detection unit 17. The driver behavior acquisition unit 1803 is configured to acquire statuses of various operation of the driver on the HMI device 20.

The subject-vehicle position acquisition unit 1804 acquires the current highly accurate position information of the subject vehicle from the locator ECU 144. The route information acquisition unit 1805 acquires route information indicating the planned travel route of the subject vehicle from the navigation device 16. The lane information acquisition unit 1806 acquires, from the high-definition map DB143, lane information on a road on which the subject vehicle is currently traveling. The “lane information” includes the number of lanes and the lane type. The “lane type” includes a slow lane, a passing lane, and the like.

The automation level determination unit 1807 determines the driving automation level of the subject vehicle based on various types of information acquired by the driving state acquisition unit 1801 and the like. Specifically, the automation level determination unit 1807 determines whether a start condition of a predetermined driving automation level is satisfied, and starts the driving automation level when an approval operation by the driver is received during the start condition being satisfied. When a continuation condition is not satisfied or a termination condition is satisfied during execution of the driving automation level, the automation level determination unit 1807 executes control necessary for terminating the driving automation level. The driving controller 18 is configured to transmit a determination result of the driving automation level by the automation level determination unit 1807 to components such as the HMI controller 27 via the in-vehicle communication line 10A.

The vehicle control unit 1808 executes a driving control of the subject vehicle based on the driving automation level determined by the automation level determination unit 1807. That is, the vehicle control unit 1808 executes control subtasks of vehicle motion, such as vehicle speed control, steering control and braking control, by controlling the traveling device 19 according to the determination result of the driving automation level by the automation level determination unit 1807.

The notification information generation unit 1809 generates notification information that needs to be notified to the driver regarding the vehicle driving control by the driving controller 18, and outputs the notification information to the HMI controller 27. The “notification information” includes the determination result of the driving automation level. The “notification information” includes various types of guidance, requests, warnings, and the like related to the vehicle driving control.

FIG. 3 illustrates functional configuration units or functional configuration blocks implemented on the HMI controller 27 by execution of program instructions. As illustrated in FIG. 3, the HMI controller 27 includes an information acquisition unit 2701, a display control unit 2702, a sound output control unit 2703, and an input operation receiving unit 2704 as functional configurations or functional units implemented on the in-vehicle microcontroller.

The information acquisition unit 2701 acquires information to be presented by the HMI device 20. More specifically, for example, the information acquisition unit 2701 acquires the notification information generated by the notification information generation unit 1809 from the driving controller 18. The display control unit 2702 controls a display operation in the HMI device 20. The “display operation” includes display of various types of information such as traffic information, route information, driving state information, and the notification information in addition to display of the video content described above. The sound output control unit 2703 controls a sound output operation in the HMI device 20, that is, the speaker 25. The input operation receiving unit 2704 is configured to receive an input operation performed by an occupant including the driver of the subject vehicle via the HMI device 20, that is, the operation unit 21, the meter switch 223, the input device 232, the CID switch 233, and the like.

### (Operation)

Hereinafter, the operations of the driving controller 18 and the HMI controller 27 according to the present embodiment, and the control method and the control program executed by the driving controller 18 and the HMI controller 27 will be described together with actions or effects obtained by the driving controller 18 and the HMI controller 27. Hereinafter, the device configuration according to the present embodiment, and the control method and the control program executed by the device may be collectively referred to as the “present embodiment”.

In the driving controller 18, the driving state acquisition unit 1801 acquires information corresponding to the various parameters related to the driving state of the subject vehicle detected by the vehicle state sensor 11. The driving environment acquisition unit 1802 acquires information corresponding to the traffic environment around the subject vehicle detected by the ambient state sensor 12 and the surrounding monitoring sensor 13. The driver behavior acquisition unit 1803 is configured to acquire the behavior of the driver in the subject vehicle. The subject-vehicle position acquisition unit 1804 acquires the current highly accurate position information of the subject vehicle. The route information acquisition unit 1805 acquires route information indicating a planned travel route of the subject vehicle. The lane information acquisition unit 1806 acquires lane information on the road on which the subject vehicle is traveling.

The automation level determination unit 1807 determines the driving automation level of the subject vehicle based on various types of information acquired by the driving state acquisition unit 1801 and the like. More specifically, the automation level determination unit 1807 determines whether a start condition of a predetermined driving automation level corresponding to any one of the SAE levels 1 to 3 is satisfied. For example, at least one of start conditions of the automated driving is satisfied when stable traveling in the slow lane, e.g. traveling at a substantially constant speed within a speed limit in the slow lane continues for a predetermined period of time after the subject vehicle enters the automated drivable road.

The notification information generation unit 1809 generates the notification information on the basis of various types of information acquired by the driving state acquisition unit 1801 and the like and/or a determination result of the driving automation level by the automation level determination unit 1807, and then outputs the notification information to the HMI controller 27. That is, when a start condition of a predetermined driving automation level, for example, the hands-on driving, the hands-off driving, or the automated driving is satisfied, the driving controller 18 notifies the HMI controller 27 that the start condition is satisfied. More specifically, for example, when the automation level determination unit 1807 determines that the start condition of the automated driving is satisfied, the notification information generation unit 1809 generates notification information corresponding to the fact that the automated driving can be started, and outputs the notification information to the HMI controller 27.

In the HMI controller 27, the information acquisition unit 2701 acquires the notification information from the driving controller 18, that is, the notification information generation unit 1809. The display control unit 2702 and the sound output control unit 2703 notify the driver of various types of information by display and/or sound output corresponding to the acquired notification information. For example, the display control unit 2702 and the sound output control unit 2703 execute information presentation for prompting the driver to perform an approval operation. The approval operation is an input operation for approving the start of the predetermined driving automation level corresponding to the start condition that has been satisfied. Then, the input operation receiving unit 2704 waits for the input operation for a predetermined time.

When the input operation receiving unit 2704 receives the approval operation, the HMI controller 27 notifies the driving controller 18 that the approval operation by the driver has been received. In the driving controller 18, when the driver behavior acquisition unit 1803 acquires information indicating that the approval operation has been received, the automation level determination unit 1807 starts execution of the approved driving automation level corresponding to the start condition that has been satisfied. Then, the vehicle control unit 1808 executes vehicle speed control, steering control, braking control, and the like according to the driving automation level executed by the automation level determination unit 1807.

The automated driving of SAE level 3 does not require, in principle, the dynamic driving tasks performed by the driver, for example, surrounding monitoring, steering control operation, and acceleration/deceleration control operation. For this reason, during the automated driving, the driver is not required to constantly hold the steering wheel 211, and is not required to constantly maintain a driving posture to the extent that allows the driver to operate the accelerator pedal and the brake pedal at any time. Thus, during the automated driving, the driver can perform a second task.

On the other hand, during the hands-on driving or the hands-off driving at SAE level 2, the driver is required to perform the dynamic driving tasks including at least surrounding monitoring. That is, during the hands-on driving, the driver is required to be in the hands-on state and is obligated to monitor the surroundings. During the hands-off driving, the driver is not required to be in the hands-on state, but is obligated to monitor the surroundings.

In the present embodiment, executable or recommended driving automation levels are different depending on lane types. More specifically, when the subject vehicle enters the automated drivable road, the hands-on driving and the hands-off driving are possible in the slow lane and the passing lane. However, in the passing lane, the hands-on driving is recommended because of necessity of moving to the slow lane as soon as possible, for example. Further, the subject vehicle can execute the automated driving by maintaining traveling in the slow lane. That is, the automated driving cannot be executed while the subject vehicle is traveling in the passing lane.

For example, the subject vehicle controlled in automated driving in which a driver is obligated to monitor the surroundings may encounter a scene where a lane change is necessary or recommended, or a scene where the driver wants to change lanes. The traffic environments may vary when the automatic lane change control is executed by the in-vehicle system 10.

For example, a situation is assumed in which the subject vehicle is traveling on a main roadway having three lanes on each way in an expressway. In this situation, when the subject vehicle is traveling in a first slow lane and there is a request for lane change from the first slow lane to an adjacent second slow lane, the lane change corresponding to this request can be executed by the in-vehicle system 10 regardless of whether the hands-on driving, the hands-off driving, or the automated driving is being executed. In addition, when the subject vehicle is traveling in the second slow lane and there is a request for lane change from the second lane to the adjacent first traveling lane, the lane change corresponding to this request can be executed by the in-vehicle system 10 regardless of whether the hands-on driving, the hands-off driving, or the automated driving is being executed.

On the other hand, in a case where the subject vehicle is traveling in the second slow lane and there is a request for lane change from the second slow lane to an adjacent passing lane, the lane change corresponding to the request can be executed by the in-vehicle system 10 on condition that the hands-on driving or the hands-off driving is being executed. However, during the automated driving, the subject vehicle is prevented from entering the passing lane. Therefore, when there is a request for the lane change from the second slow lane to the passing lane (e.g., a request for passing a preceding vehicle) during the automated driving, it is necessary to interrupt or terminate the automated driving in order to execute the lane change corresponding to the request.

The behavior of the subject vehicle during lane change and a time actually required for the lane change may change according to the speed of the subject vehicle and the traffic situation on the road on which the subject vehicle is traveling. More specifically, during the lane change executed by the in-vehicle system 10, a distance or required time between a start point and a completion point of the lane change changes depending on presence or absence of another vehicle around the subject vehicle, the vehicle speed of the subject vehicle, and the like.

On the other hand, it may be necessary to lower the driving automation level from the automated driving due to an approach to the end point of the automated drivable road, a schedule of the subject vehicle exiting from the automated drivable road, an occurrence of the impediment section on a traveling route of the subject vehicle, or the like. In this case, when the completion point of the lane change becomes far away from the subject vehicle or the required time becomes long, there is a possibility that the lane change is not completed before entering a transition region in which the driving automation level changes. As a result, a situation where the automated driving needs to be ended in the middle of the lane change may occur. The occurrence of such a situation is inconvenient for the driver. In addition, at a merging point or a curve point, there is a high possibility that the number of surrounding vehicles and the number of occurrences of lane change and wobbling of a surrounding vehicle become higher than those on a normal straight road. In such a situation where the unspecified risks are high, the automatic lane change executed by the in-vehicle system 10 may deteriorate a quality of the lane change, i.e. the lane change may not be executed smoothly.

Therefore, in the present embodiment, even when the driver gives an execution start instruction of lane change during the automated driving without obligation of surroundings monitoring, the lane change control by the in-vehicle system 10, that is, the lane change control by the driving controller 18 is restricted in the following cases. Further, in the present embodiment, when such restriction of the lane change control is executed, the driver is notified that the lane change control is restricted. Accordingly, the convenience of the vehicle capable of the automatic lane change control by the in-vehicle system 10 can be improved, and the driver can be given a sense of safety by notifying the driver of the situation.

A first case is where the subject vehicle is located within a predetermined distance (for example, 3 km) or within a predetermined time (for example, 3 minutes) to the transition region where the driving automation level changes.

A second case is where a merging point or a curve point is present in a lane change destination region. The lane change destination region is a predetermined range (for example, within a predetermined distance or a predetermined time from the position of the subject vehicle) in a change destination lane that is a destination lane of the lane change and next to a traveling lane of the subject vehicle.

Here, the “transition region” is, for example, a region (i.e., road section) which is normally set for takeover of driving when the automated driving is ended. Further, the “transition region” is, for example, an impediment section or an impediment point acquired based on the traffic information, or a region within a predetermined distance range including the impediment section or the impediment point. The “second case” typically corresponds to a case where the subject vehicle is positioned before a branch. However, the “second case” also includes a case where the subject vehicle is simply positioned before a curve in a main line having two or more lanes on each way without branching or merging, in other words, a case where a curve point exists in both a “region on a side of the subject vehicle where the lane change is performed” and a “region on another side of the subject vehicle where the lane change is not performed”.

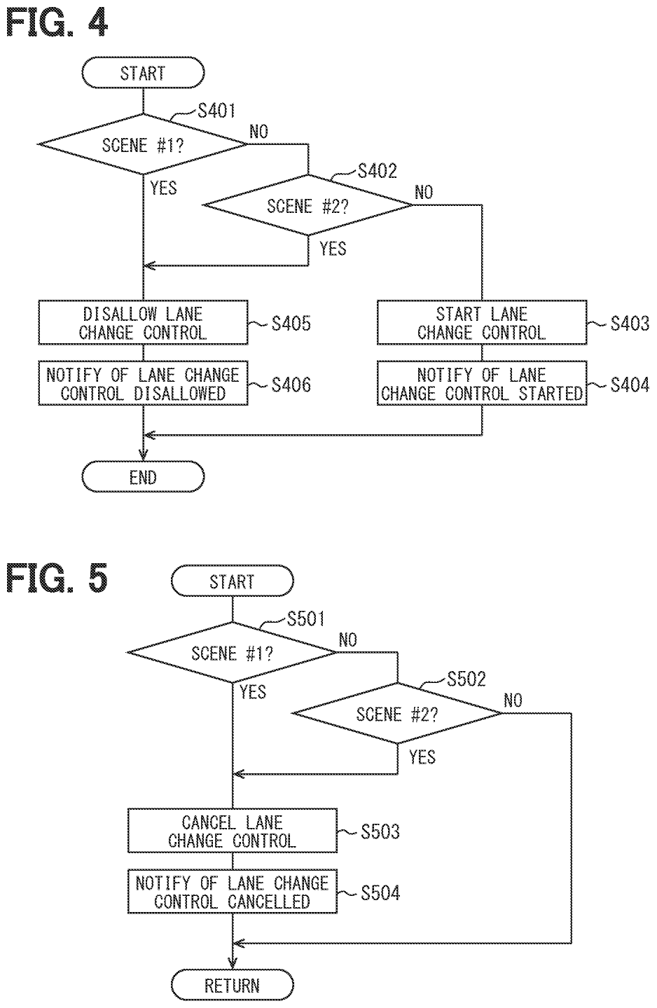

FIG. 4 shows an example in which the restriction of the lane change control includes disallowing execution of the lane change control. In the flowchart shown in FIG. 4, “S” is an abbreviation for “step”. Further, “scene #1” indicates the “first case”, and “scene #2” indicates the “second case”. The same applies to the flowcharts shown in FIGS. 5 to 8.

The flowchart shown in FIG. 4 illustrates a program executed by the driving control processor 181 and the HCU processor 271. The program illustrated in FIG. 4 is activated when the driver performs a trigger operation (for example, an operation of the turn signal switch 213) for lane change during automated driving. Hereinafter, the driving control processor 181 and the HCU processor 271 are collectively and simply referred to as a “processor”. Similarly, the driving control memory 182 and the HCU memory 272 are collectively and simply referred to as a “memory”. That is, the processing according to the present embodiment is typically implemented by the driving control processor 181 and the HCU processor 271 cooperating with each other. In other words, the processing according to the present embodiment is implemented by one or more processors and one or more memories. The same applies to FIG. 5 and the following drawings.

When the program illustrated in FIG. 4 is started, first, in step 401, the processor determines whether a traveling situation of the subject vehicle corresponds to the “first case” at the present time point. When it does not correspond to the “first case” (i.e., NO in step 401), the processor executes a process of step 402. In step 402, the processor determines whether the traveling situation of the subject vehicle corresponds to the “second case” at the present time point.

When the traveling situation of the subject vehicle does not correspond to the “first case” or the “second case” at the present time point (that is, NO in step 402), the processor executes processes of step 403 and step 404, and then ends the present program. In step 403, the processor starts the lane change control by the driving controller 18. In step 404, the processor uses the HMI device 20 to notify the driver that the lane change control has been started.

When the traveling situation of the subject vehicle corresponds to the “first case” or the “second case” at the present time point (that is, YES in step 401 or step 402), the processor executes processes of step 405 and step 406, and then ends the present program. In step 405, the processor disallows a start of the lane change control. In step 406, the processor uses the HMI device 20 to notify the driver that the start of the lane change control has been disallowed.

FIG. 5 illustrates an example in which the restriction of the lane change control includes cancelling the execution of the lane change control during the lane change control is being executed. The program illustrated in FIG. 5 is repeatedly activated at predetermined time intervals from the start of the execution of the lane change control until the lane change is substantially completed, that is, until the vehicle width center of the subject vehicle enters the change destination lane.

When the program illustrated in FIG. 5 is started, first, in step 501, the processor determines whether the traveling situation of the subject vehicle corresponds to the “first case” at the present time point. When it does not correspond to the “first case” (i.e., NO in step 501), the processor executes a process of step 502. In step 502, the processor determines whether the traveling situation of the subject vehicle corresponds to the “second case” at the present time point.

When the traveling situation of the subject vehicle corresponds to the “first case” or the “second case” at the present time point (that is, YES in step 501 or step 502), the processor executes processes of step 503 and step 504, and then ends the present program. In step 503, the processor cancels the lane change control and starts a vehicle control necessary for cancelling the lane change. In step 504, the processor uses the HMI device 20 to notify the driver that the lane change has been cancelled. On the other hand, when the traveling situation of the subject vehicle does not correspond to the “first case” or the “second case” at the present time point (that is, NO in step 502), the processor skips the processes of step 503 and step 504, and then ends the present program.

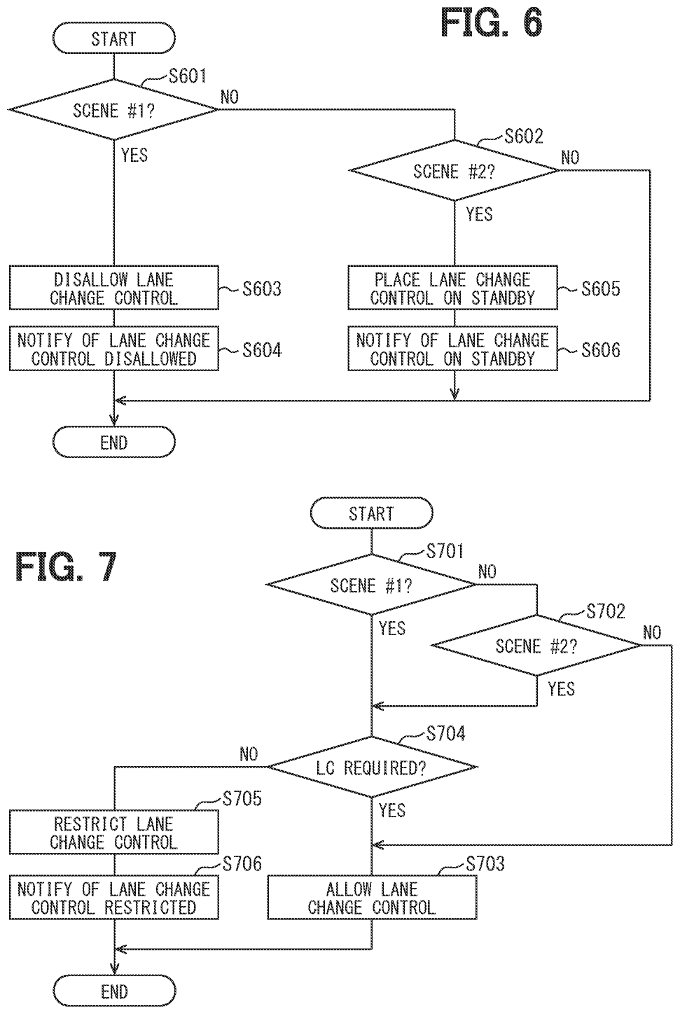

FIG. 6 illustrates an example in which the restriction of the lane change control includes placing the lane change control on standby. As in the case of FIG. 4, the program illustrated in FIG. 6 is activated when the driver performs a trigger operation for lane change during automated driving.

When the program illustrated in FIG. 6 is started, first, in step 601, the processor determines whether the traveling situation of the subject vehicle corresponds to the “first case” at the present time point. When it does not correspond to the “first case” (i.e., NO in step 601), the processor executes a process of step 602. In step 602, the processor determines whether the traveling situation of the subject vehicle corresponds to the “second case” at the present time point.

When the traveling situation of the subject vehicle corresponds to the “first case” at the present time point (that is, YES in step 601), the processor executes processes of step 603 and step 604, and then ends the present program. In step 603, the processor disallows execution of the lane change control. In step 604, the processor uses the HMI device 20 to notify the driver that the execution of the lane change control has been disallowed.

When the traveling situation of the subject vehicle corresponds to the “second case” at the present time point (that is, YES in step 602), the processor executes processes of step 605 and step 606, and then ends the present program. In step 605, the processor places the lane change control on standby. In step 606, the processor uses the HMI device 20 to notify the driver that the lane change control has been placed on standby. On the other hand, when the traveling situation of the subject vehicle does not correspond to the “first case” or the “second case” at the present time point (that is, NO in step 602), the processor skips the processes of step 503 to step 506, and then ends the present program.

The example, in which the restriction of the lane change control includes placing the lane change control on standby, is also applicable to a situation in which the lane change control is being executed. In this case, the flowchart shown in FIG. 5 is modified as shown in FIG. 6. That is, when the determination result in step 502 is “YES”, the processes of steps 605 and 606 are executed instead of the processes of steps 503 and 504.

In a case where a lane change is required according to a traveling route set in advance for the subject vehicle, it is necessary to execute the lane change as early as possible even if the case corresponds to the “first case” or the “second case”. Therefore, in this case, the in-vehicle system 10 may allow execution of the lane change control while maintaining the automated driving. Alternatively, in this case, the in-vehicle system 10 may propose to the driver to transition from the automated driving without the obligation of surroundings monitoring to a driving automation level with the obligation of surroundings monitoring.

FIG. 7 illustrates an example in which execution of the lane change control is allowed while the automated driving is maintained in a case where the lane change is required according to the traveling route set in advance for the subject vehicle even when the traveling situation of the subject vehicle corresponds to the “first case” or the “second case”. That is, the flowchart of FIG. 7 is obtained by partially modifying the flowchart of FIG. 4 and the like. In FIG. 7, “LC” is an abbreviation of “lane change”.

When the program illustrated in FIG. 7 is started, first, in step 701, the processor determines whether the traveling situation of the subject vehicle corresponds to the “first case” at the present time point. When it does not correspond to the “first case” (i.e., NO in step 701), the processor executes a process of step 702. In step 702, the processor determines whether the traveling situation of the subject vehicle corresponds to the “second case” at the present time point.

When the traveling situation of the subject vehicle does not correspond to the “first case” or the “second case” at the present time point (that is, NO in step 702), the processor executes a process of step 703. In step 703, the processor allows the execution of the lane change control. That is, in this case, the restriction (i.e., disallowing, cancelling or placing on standby) of the lane change control is not executed.

When the traveling situation of the subject vehicle corresponds to the “first case” or the “second case” at the present time point (that is, YES in step 701 or step 702), the processor executes a process of step 704. In step 704, the processor determines whether a lane change is required according to a traveling route set in advance for the subject vehicle.

When the lane change is required (that is, YES in step 704), the processor executes the process of step 703. At this time, the processor may cause the HMI device 20 to execute notification for prompting the driver to monitor the surroundings. On the other hand, when the lane change is not required (that is, NO in step 704), the processor executes the processes of step 705 and step 706. In step 705, the processor restricts the lane change control. In step 706, the processor uses the HMI device 20 to notify the driver that the lane change control has been restricted.

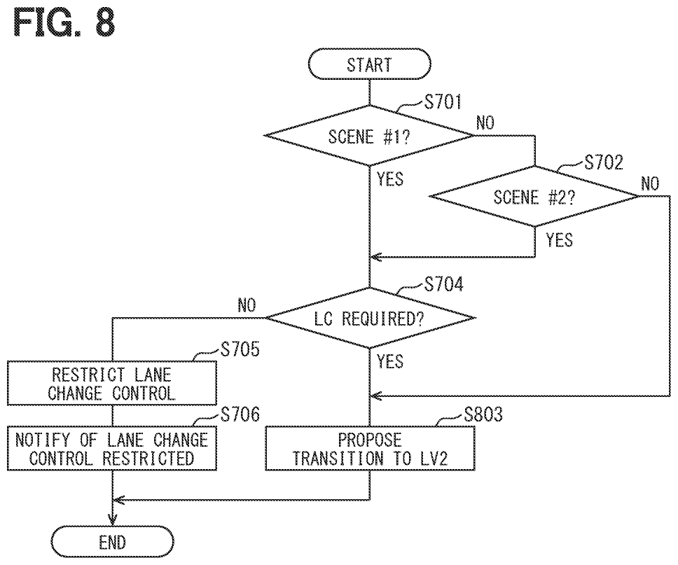

FIG. 8 illustrates an example of proposing to the driver to transition from the automated driving to SAE level 2 when the lane change is required according to the traveling route set in advance for the subject vehicle and the traveling situation of the subject vehicle corresponds to the “first case” or the “second case”. That is, in the flowchart of FIG. 8, step 703 in the flowchart of FIG. 7 is changed to step 803. In step 803, the processor proposes to the driver to transition from the automated driving to SAE level 2.

### Second Embodiment

Hereinafter, a second embodiment will be described. In the following description of the second embodiment, portions different from those of the first embodiment will be mainly described. In the first embodiment and the second embodiment, portions that are the same or equivalent to each other are assigned the same reference numerals. Therefore, in the following description of the second embodiment, the description of the first embodiment may be appropriately incorporated for the components having the same reference numerals as those of the first embodiment, unless there is a technical contradiction or a special additional description.

The configuration of the in-vehicle system 10 according to the present embodiment is the same as that of the first embodiment. That is, the in-vehicle system 10 according to the present embodiment has the configurations illustrated in FIGS. 1 to 3. However, the present embodiment is slightly different from the first embodiment in the operation mode and the functional configuration corresponding to this. During automated driving, a driver does not need to monitor the surroundings. However, in a passing control, lane change is executed twice in a short period of time. Further, a vehicle behavior during the lane change varies depending on a situation of surrounding vehicles. Therefore, occupants including the driver may feel uneasy due to change of the vehicle behavior occurring twice in the short period of time during the passing control.

Therefore, in the present embodiment, in a case where a driver performs a trigger operation that is an operation to issue an execution start instruction of the passing control during automated driving without an obligation of surrounding monitoring, a notification prompting the driver to monitor the surroundings at the time of the lane change during the passing control is executed. According to the present embodiment, the notification for prompting the surroundings monitoring during the lane change in which the change of the vehicle behavior is the largest in the passing control can prompt the occupants including the driver to prepare for change of the vehicle behavior, and thereby a sense of safety can be given to the occupants.

Further, during the passing control executed by the in-vehicle system 10, a distance or required time between a start point and a completion point of the passing control changes depending on presence or absence of another vehicle around the subject vehicle, the vehicle speed of the subject vehicle, and the like. Therefore, when the completion point of the passing control becomes far away from the subject vehicle or the required time becomes long, there is a possibility that the passing control is not completed before entering a transition region in which the driving automation level changes. As a result, a situation where the automated driving needs to be ended in the middle of the passing control may occur. In addition, at a merging point or a curve point, there is a high possibility that the number of surrounding vehicles and the number of occurrences of lane change and wobbling of a surrounding vehicle become higher than those on a normal straight road. In such a situation where the unspecified risks are high, the automatic passing control executed by the in-vehicle system 10 may deteriorate a quality of passing, i.e. the passing control may not be executed smoothly.

Therefore, in the present embodiment, in order to solve the above-described issue, the passing control is restricted in a predetermined case. The “predetermined case” mentioned here is any one of the following cases.

A case is where a lane re-change point is located within a predetermined distance or within a predetermined time to the transition region where the driving automation level changes. Here, the “lane re-change point” is a point at which a lane re-change is scheduled to be executed. The “lane re-change” is a lane change for returning from a change destination lane to an originally traveling lane after lane change from the originally traveling lane to the change destination lane. The originally traveling lane is a traveling lane of the subject vehicle before start of the passing control. The change destination lane is a lane for passing and located next to the originally traveling lane. The “lane re-change” may also be referred to as a second-time lane change in the passing control.

Another case is where a merging point or a curve point is present in the lane change destination region at the lane re-change point.

More specifically, for example, in the present embodiment, when the traveling situation of the subject vehicle is a “specific scene” corresponding to the“predetermined case”, the start of the passing control is disallowed, and/or the passing control that has been started is cancelled. According to the present embodiment, since the lane change can be stably executed during the passing control, convenience is improved in the vehicle capable of the automatic passing control executed by the in-vehicle system 10.

In addition, in a case where the change destination lane at the time of a first-time lane change from the originally traveling lane in the passing control is a lane (e.g., passing lane) in which the automated driving without obligation of surrounding monitoring is not permitted, i.e., only the automated driving with obligation of surrounding monitoring is permitted, it is necessary to interrupt or terminate the automated driving and take over the driving in order to perform passing. For this reason, in such a case, even if a passing proposal is executed by the in-vehicle system 10, approval of the proposal cause termination of the automated driving and deterioration in convenience for the driver.

Therefore, in the present embodiment, the passing proposal is made to the driver during the automated driving without the obligation of surrounding monitoring on the condition that the adjacent lane which is the lane change destination at the time of the first-time lane change in the passing control is a lane in which the automated driving without the obligation of surrounding monitoring is permitted. This improves the convenience of the vehicle in which the automatic passing control executed by the in-vehicle system 10 is available.

In addition, the second-time lane change for returning to the originally traveling lane is relatively safer than the first-time lane change during the passing control. Therefore, in the present embodiment, a notification for prompting the driver to monitor the surroundings at the time of the first-time lane change during the passing control is executed more strongly than a notification for prompting the driver to monitor the surroundings at the time of the second-time lane change. In other words, the notification at the time of the first-time lane change is more emphasized than the notification at the time of the second-time lane change auditorily, visually or/and haptically, for example. This makes it possible to call the driver's attention in an appropriate manner in accordance with the progress of the passing control.

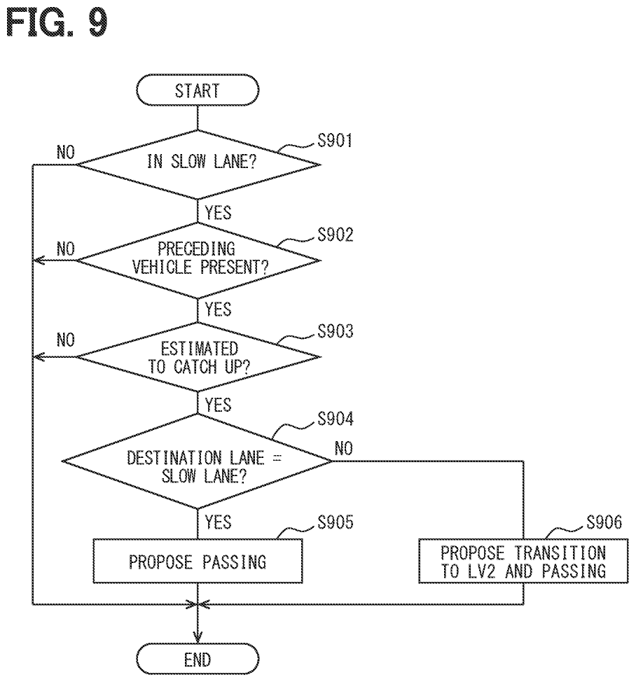

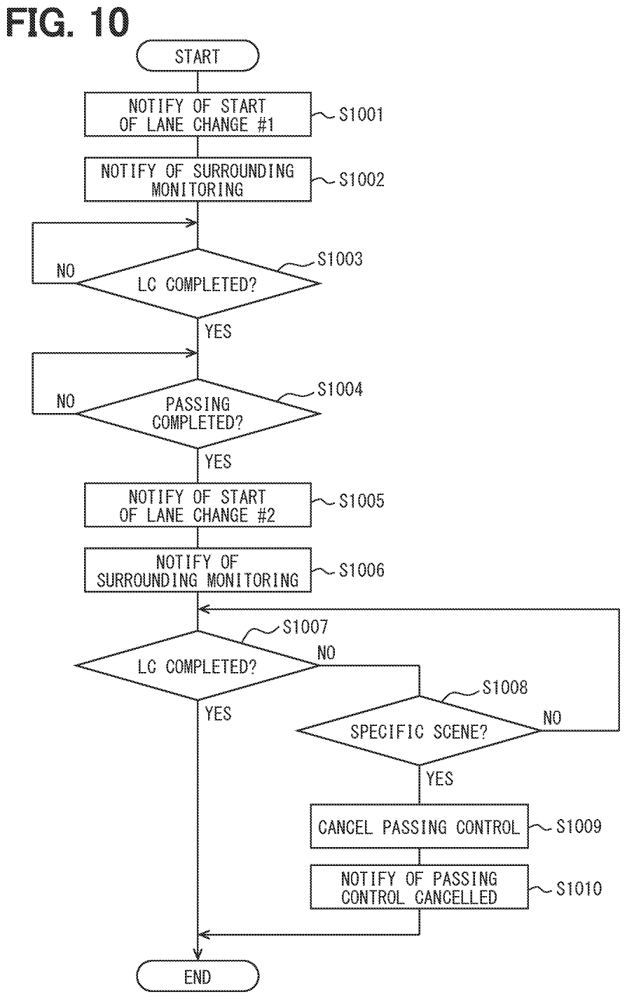

FIGS. 9 and 10 are flowcharts corresponding to the present embodiment. The flowchart illustrated in FIG. 9 corresponds to the process related to the passing proposal. The flowchart illustrated in FIG. 10 corresponds to processing when the driver approves the passing proposal and the passing control is started. The processing according to the present embodiment is also implemented by one or more processors and one or more memories as in the first embodiment.

The program illustrated in FIG. 9 is repeatedly activated at predetermined time intervals in a situation in which automated driving is being executed, neither lane change control nor passing control is being performed, and the subject vehicle is not located within a predetermined distance or within a predetermined time to a transition area for takeover of driving. When the program illustrated in FIG. 9 is started, first, in step 901, the processor determines whether the traveling lane is a slow lane.

For example, there is a case where the subject vehicle is currently traveling on a branch road, that is, a ramp way that branches off from a main road at a junction where multiple automated drivable roads intersect. In this case, although the subject vehicle is running in the automated driving, the subject vehicle is not traveling in the slow lane. In this case, even if there is a preceding vehicle traveling at a low speed, the passing proposal should not be made. Therefore, in this case (i.e., NO in step 901), the processor skips all the processes of step 902 and the subsequent steps, and temporarily ends the present program.

In a case where the lane change destination is a slow lane (i.e., YES in step 901), the processor makes the processing proceed to step 902. In step 902, the processor determines whether a preceding vehicle is present in front of the subject vehicle in the currently traveling lane and within a predetermined distance range from the subject vehicle. When such a preceding vehicle is not present (that is, NO in step 902), the subject vehicle is not in a passing scene at the present time. Therefore, in this case, the processor skips all the processes of step 903 and the subsequent steps, and temporarily ends the present program.

When a preceding vehicle is present in front of the subject vehicle in the currently traveling lane and within the predetermined distance range from the subject vehicle (i.e., YES in step 902), the processor causes the process to proceed to step 903. In step 903, the processor determines whether the subject vehicle is estimated to catch up with the preceding vehicle.

In a case where the preceding vehicle is not traveling at a speed lower than the set speed of the subject vehicle and the subject vehicle is under an inter-vehicle distance control in which the preceding vehicle is a target to be followed by the subject vehicle, it is not a scene in which the subject vehicle is estimated to catch up with the preceding vehicle. Therefore, in this case (i.e., NO in step 903), the processor skips all the processes of step 904 and the subsequent steps, and temporarily ends the present program.

When the subject vehicle is estimated to catch up with the preceding vehicle (i.e., YES in step 903), the subject vehicle is in a passing scene at the present time point. In this case, the processor advances the process to step 904. In step 904, the processor determines whether the lane change destination from the currently traveling lane at the time of passing the preceding vehicle is a slow lane.

When the change destination lane is the slow lane (i.e., YES in step 904), the processor executes the process of step 905 and then ends the present program. In step 905, the processor executes the passing proposal to the driver. When the driver approves the passing proposal, the processor starts the passing control while maintaining the automated driving.

On the other hand, when the change destination lane is a passing lane (i.e., NO in step 904), the processor executes the process of step 906 and then ends the present program. In step 906, the processor proposes the driver to transition to SAE level 2 and to execute automatic passing control after the transition.

FIG. 10 illustrates a process after the process of step 905 is executed. First, in step 1001, the processor executes a notification of a start of the first-time lane change that is a lane change from a pre-passing traveling lane in which the subject vehicle travels before a start of passing.

Next, in step 1002, the processor executes a notification for prompting the driver to perform surrounding monitoring at the time of lane change. The notification in step 1002 is executed relatively strongly. That is, the notification in step 1002 is output as a sound in a relatively large volume and is displayed in a relatively conspicuous manner.

Subsequently, in step 1003, the processor determines whether the first-time lane change has been completed. Until the first-time lane change is completed (i.e., NO in step 1003), the processor repeats the process of step 1003. When the first-time lane change is completed, the processor proceeds to step 1004.

In step 1004, the processor determines whether the passing of the other vehicle that was the preceding vehicle to be overtaken has been completed. That is, the processor determines whether the inter-vehicle distance between the subject vehicle and the other vehicle has increased to such an extent that the second-time lane change is sufficiently executable for returning the subject vehicle to the pre-passing traveling lane. Until the passing is completed (i.e., NO in step 1004), the processor repeats the processing of step 1004. When the passing is completed, the processor proceeds to step 1005 to step 1007.

In step 1005, the processor executes notification of a start of the second-time lane change. In step 1006, the processor executes a notification prompting the driver to perform surrounding monitoring at the time of lane change. The notification in step 1006 is weaker than the notification in step 1002. In step 1007, the processor determines whether the second-time lane change has been completed. Until the second-time lane change is completed (i.e., NO in step 1007), the processor proceeds from step 1007 to step 1008.

In step 1008, the processor determines whether the traveling situation of the subject vehicle corresponds to the “specific scene”. When the traveling situation of the subject vehicle does not correspond to the “specific scene” (i.e., NO in step 1008), the processor returns the process to step 1007. When the second-time lane change is completed while the traveling situation of the subject vehicle does not correspond to the “specific scene” (i.e., YES in step 1007), the processor ends the passing control.

On the other hand, when the traveling situation of the subject vehicle corresponds to the “specific scene” (i.e., YES in step 1008), the processor executes the processes of step 1009 and step 1010, and then ends the passing control. In step 1009, the processor cancels the passing control and starts the vehicle control necessary for canceling the passing control. In step 1010, the processor notifies the driver that the passing control has been cancelled.

### (Modifications)

The present disclosure is not necessarily limited to the above embodiments. Thus, it is possible to appropriately modify the above-described embodiments. Hereinafter, typical modifications will be described. In the following descriptions of the modifications, parts different from the above embodiments will be mainly described. In addition, in the above-described embodiments and the modifications, the same reference numerals are given to the same or equivalent parts. Therefore, in the following descriptions of the modifications, the descriptions in the above embodiments can be appropriately incorporated for the components having the same reference numerals as those in the above embodiments, unless there is a technical contradiction or a special additional description.

The present disclosure is not limited to the specific apparatus configuration described in the above embodiments. That is, for example, a vehicle on which the in-vehicle system 10 is mounted is not limited to a four-wheeled car. More specifically, such a vehicle may be a three-wheeled car, or may be a six-wheeled or eight-wheeled car, such as a cargo truck. The type of the vehicle may be a conventional car including only an internal combustion engine, may be an electric car or a fuel cell car not including an internal combustion engine, or may be what is called a hybrid car. The shape and structure of the vehicle body in the vehicle are not limited to a box shape, that is, a substantially rectangular shape in top view. The application of the vehicle, the position of the steering wheel 211 or the driver's seat, the number of the occupants, and the like are not particularly limited.

In the above embodiments, the in-vehicle system 10 is configured to execute the automated driving corresponding to the SAE level 3, which is executed on the condition that the vehicle travels on a predetermined automated drivable road within the legal speed range. However, the present disclosure is not necessarily limited to such a configuration. That is, the present disclosure is also favorably applicable to other types of automated driving.

In the above embodiments, the in-vehicle system 10 is configured to execute the vehicle-controlling operation corresponding to SAE levels 1 to 3. More specifically, the in-vehicle system 10 can selectively execute any one of the hands-on driving of SAE level 2, the hands-off driving of SAE level 2, and the automated driving of SAE level 3, as the driving automation level of SAE level 2 or higher. However, the present disclosure is not necessarily limited to such a configuration. That is, for example, the present disclosure can be suitably applied to a case where a vehicle-controlling operations corresponding to SAE levels 1 to 5 can be executed. Further, the level or category of driving automation in the present disclosure is not limited to those defined in “SAE J3016”.

More specifically, the “automated driving” in the above embodiments is a driving automation level that corresponds to levels 3 to 5 in “SAE J3016”, and at which the driving automation system is in charge of all the dynamic driving tasks, that is, executes all the dynamic driving tasks. Therefore, the definition of the “automated driving” in the above embodiments naturally includes a fact that the surrounding-monitoring obligation is not imposed on the driver. However, the present disclosure is not necessarily limited to such a configuration.

That is, for example, depending on the definition contents of the “automated driving”, not only the “automated driving without the obligation of surrounding monitoring” but also the “automated driving with the obligation of surrounding monitoring” may be included in a concept of the automated driving. More specifically, for example, the hands-on driving and the hands-off driving in the above embodiments can also be interpreted as the “automated driving with the obligation of surrounding monitoring”. The “automated driving” in this case is a concept including what is called “partial automated driving” in which the driver is in charge of, i.e. performs some of the dynamic driving tasks such as the obligation of surrounding monitoring. The “partial automated driving” can be evaluated as being substantially synonymous with “advanced driving assistance”.

As described above, in the road traffic system of each country, the types and conditions of the automated driving (for example, the executable roads, traveling speed range, lane change approval and prohibition, and the like) can be appropriately considered according to the domestic circumstances and the like. Therefore, the present disclosure may be implemented in specifications adapted to the road traffic system of each country.

As the communication standard constituting the in-vehicle system 10, a communication standard other than CAN (international registered trademark), for example, FlexRay (internationally registered trademark) or the like may be adopted. The communication standard constituting the in-vehicle system 10 may not be limited to one type. For example, the in-vehicle system 10 may have a subnetwork line conforming to a communication standard such as LIN. LIN is an abbreviation for Local Interconnect Network.

The vehicle state sensor 11, the ambient state sensor 12, and the surrounding monitoring sensor 13 may be also not limited to the above examples. For example, the surrounding monitoring sensor 13 may include sonar, that is, an ultrasonic sensor. Alternatively, the surrounding monitoring sensor 13 may include two or more types of millimeter-wave radar sensor, a sub-millimeter-wave radar sensor, a laser radar sensor, and an ultrasonic sensor. The number of the installed various sensors is not particularly limited.

The locator 14 may not be also limited to the above examples. For example, the locator 14 may not have the configuration incorporating the gyro sensor and the acceleration sensor. Specifically, the inertia acquisition unit 142 may receive output signals from an angular velocity sensor and an acceleration sensor provided outside the locator 14 as the vehicle state sensor 11.

The communication module 15 may be omitted. That is, the traffic information can be obtained by the navigation device 16. Alternatively, the navigation device 16 may have a configuration including the locator 14 and the communication module 15.

The navigation device 16 may be connected to the HMI controller 27 to be capable of information communication via a sub-communication line different from the in-vehicle communication line 10A.

The navigation device 16 may have a display screen exclusive to navigation screen display different from the HMI device 20. Alternatively, the navigation device 16 may be provided as a part of the HMI device 20. Specifically, for example, the navigation device 16 may be integrated with the CID device 23.

The driver state detection unit 17 may be connected to the HMI controller 27 to be capable of information communication via a sub-communication line different from the in-vehicle communication line 10A.

The driver state detection unit 17 is not limited to a configuration that senses the direction of the line of sight or the face of the driver by image recognition. That is, for example, the driver state detection unit 17 may have a configuration in which the seated posture and the steering-wheel-holding state of the driver are sensed by a sensor of a type different from an image sensor.

The HMI device 20 may not be limited to the configuration including the meter panel 22, the HUD device 24, and the CID device 23. That is, for example, the HMI device 20 may not include the CID device 23 and/or the HUD device 24.

The meter 221 and the meter display 222 may be implemented by one display device. In this case, the meter 221 may be provided as display regions at both left and right ends of the one display device, which is a liquid crystal or organic EL display. That is, the meter 221 can be implemented by displaying, as an image, a bezel, pointers, scales, and the like corresponding to a tachometer, a speedometer, a water temperature gauge, and the like. The meter display 222 may be provided as a display region in the display device except for the meter 221.

The input device 232 may include a pointing device or the like operated by the driver's hand instead of or in addition to the touch panel superimposed on the CID display 231. The input device 232 may include a voice input device that detects the utterance of the driver.

In the above embodiments, the driving controller 18 and the HMI controller 27 have a configuration as a so-called in-vehicle microcontroller equipped with a CPU and the like. However, the present disclosure is not limited to the configuration.

For example, all or part of the driving controller 18 may be configured to include a digital circuit configured to enable the above-mentioned operation, for example, an ASIC or an FPGA. ASIC is an abbreviation for Application Special Integrated Circuit. FPGA is an abbreviation for Field Programmable Gate Array. That is, in the driving controller 18, the in-vehicle microcontroller part and the digital circuit part can coexist. The same applies to the HMI controller 27.

The program according to the present disclosure capable of performing various operations, procedures, or processing described in the above embodiments can be downloaded or upgraded via V2X communication by the communication module 15 or the like. V2X is an abbreviation for Vehicle to X. Alternatively, such a program can be downloaded or upgraded via terminal equipment provided in a manufacturing factory, a maintenance factory, a shop, or the like of the vehicle. The program may be stored in a memory card, an optical disk, a magnetic disk, or the like.

As described above, each functional configuration and method described above may be implemented by a dedicated computer provided by configuring a processor and a memory programmed to execute one or a plurality of functions embodied by a computer program. Alternatively, the functional blocks and method described in the present disclosure may be implemented by a special purpose computer including a processor with one or more dedicated hardware logic circuits. Alternatively, the functional blocks and method described in the present disclosure may be implemented by a combination of (a) a processor and a memory programmed to execute one or more functions embodied by a computer program and (b) a processor including one or more dedicated hardware logic circuits. The computer program may be stored in a computer-readable non-transitory tangible storage medium as an instruction to be executed by the computer. That is, each functional configuration and method described above can also be expressed as a computer program including procedures for implementing the functional configuration and method, or a non-transitory tangible storage medium storing the program.

The present disclosure is not limited to the specific operation examples shown in the above embodiments. For example, the present disclosure is not limited to an aspect realized by multiple processors and multiple memories. That is, the present disclosure can also be realized by one processor and one memory. Specifically, for example, it can be understood that all of the processes according to the present disclosure are executed by the driving controller 18. In other words, the processing for executing various notifications can be grasped as processing executed by the notification information generation unit 1809.

Similar expressions such as “acquisition”, “calculation”, “estimation”, “detection”, “sensing”, and “determination” can be appropriately replaced with one another within a range free from technical conflict. “Sensing” or “detection” and “extraction” can be appropriately replaced within a range including no technical contradiction. Similarly, “within a predetermined value” and “less than a predetermined value” can be appropriately replaced with each other.

The constituent element(s) of each of the above embodiments and the above modifications is/are not necessarily essential unless it is specifically stated that the constituent element(s) is/are essential in the above embodiments, or unless the constituent element(s) is/are obviously essential in principle. When numerical values such as the number, amount, and range of elements are mentioned, the present disclosure is not limited to the specific numerical values unless otherwise specified as essential or obviously limited to the specific numerical values in principle. Similarly, in the case where the shape, the direction, the positional relationship, and/or the like of the constituent element(s) is specified, the present disclosure is not necessarily limited to the shape, the direction, the positional relationship, and/or the like unless the shape, the direction, the positional relationship, and/or the like is/are indicated as essential or is/are obviously essential in principle.

The modifications are also not necessarily limited to the above examples. For example, multiple embodiments may be combined with each other under a condition that they are not technically inconsistent. Further, a plurality of modifications may be combined together. Further, all or part of the above embodiments and all or part of the modifications may be combined with each other unless there is a technical contradiction.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A controller configured to execute lane change control causing a vehicle capable of automated driving to make a lane change, the lane change control including at least automated steering control, the controller comprising:
at least one processor; and
at least one memory which is a non-transitory tangible storage medium configured to store data and program instructions to be used by the processor, wherein
the at least one processor is, when the program instructions stored in the at least one memory is executed by the at least one processor, configured to carry out restricting the lane change control regardless of an instruction of a driver to start a lane change during automated driving without an obligation of surrounding monitoring
in a first case where a transition region where a driving automation level changes is located within a predetermined distance or within a predetermined time from the vehicle, or
in a second case where a merging point or a curve point is present in a lane change destination region.

2. The controller according to claim 1, wherein
the restricting the lane change control includes disallowing execution of the lane change control.

3. The controller according to claim 1, wherein
the restricting the lane change control includes canceling execution of the lane change control that has been started.

4. The controller according to claim 1, wherein
the restricting the lane change control includes placing the lane change control on standby.

5. The controller according to claim 1, wherein
the processor is further configured to carry out notifying the driver that the lane change control is restricted.

6. The controller according to claim 1, wherein
the processor is further configured to, when a lane change is required according to a traveling route set in advance for the vehicle, carry out
allowing execution of the lane change control even in the first case or the second case, or
proposing, to the driver, shifting from the automated driving without the obligation of surrounding monitoring to an automated driving with the obligation of surrounding monitoring, in which the lane change control is executable, in the first case or the second case.

7. A controller configured to execute passing control causing a vehicle capable of automated driving to pass another vehicle, the passing control including at least automated steering control, the controller comprising:
at least one processor; and
at least one memory which is a non-transitory tangible storage medium configured to store data and program instructions to be used by the processor, wherein
the at least one processor is, when the program instructions stored in the at least one memory is executed by the at least one processor, configured to carry out restricting the passing control
in a case where a transition region where a driving automation level changes is located within a predetermined distance or within a predetermined time from a lane re-change point at which a lane re-change is scheduled to be executed for the vehicle returning from an adjacent lane to an originally traveling lane after a lane change from the originally traveling lane to the adjacent lane for passing the other vehicle, the originally traveling lane is a lane in which the vehicle is traveling before a start of the passing control, or
in a case where a merging point or a curve point is present in a lane change destination region at the lane re-change point.

8. A controller for a vehicle capable of automated driving, the vehicle being configured to execute passing control causing the vehicle to pass another vehicle, the passing control including at least automated steering control, the controller comprising:
at least one processor; and
at least one memory which is a non-transitory tangible storage medium configured to store data and program instructions to be used in the processor, wherein
the at least one processor is, when the program instructions stored in the at least one memory is executed by the at least one processor, configured to carry out executing a notification prompting a driver to perform surrounding monitoring at a time of a lane change during the passing control when having received an instruction of the driver to start execution of the passing control during automated driving without an obligation of surrounding monitoring.

9. The controller according to claim 7, wherein
the processor is further configured to carry out proposing passing the other vehicle to a driver during the automated driving without an obligation of surrounding monitoring on a condition that an adjacent lane is a lane in which the automated driving without the obligation of surrounding monitoring is permitted, the adjacent lane being a destination lane of a first-time lane change in the passing control.

10. The controller according to claim 7, wherein
the processor is further configured to carry out executing a notification for prompting a driver of the vehicle to perform surrounding monitoring at time of a first-time lane change and a second-time lane change in the passing control such that the notification at the time of the first-time lane change is stronger than the notification at the time of the second-time lane change.
